(19) United States
(12) Patent Application Publication
(10) Pub. No.: US 2010/0028688 A1
(43) Pub. Date: Feb. 4, 2010

(54) ADHESIVE FOR PLASTIC-LINED CONCRETE STRUCTURE AND METHOD OF PRODUCING A PLASTIC-LINED CONCRETE STRUCTURE

(75) Inventor: David S. Kulis, Chicago, IL (US)

Correspondence Address: ZARLEY LAW FIRM P.L.C., CAPITAL SQUARE, 400 LOCUST, SUITE 200, DES MOINES, IA, 50309-2350, US

(73) Assignee: WILBERT FUNERAL SERVICES INC., Broadview, IL (US)

(21) Appl. No.: 12/184,862

(22) Filed: Aug. 1, 2008

(51) Int. Cl. B32B 27/38; B29C 65/00

(52) U.S. Cl. 428/414; 156/196

(57) ABSTRACT

A composite structure and method of making the same. The composite structure has a thermoplastic liner that is bonded to wet cement by a thermosetting resin adhesive. The thermosetting resin adhesive contains an epoxy resin system, solvent and a primer therein to form a solvent blend. The solvent blend is formed such that the blend is not flammable and is able to bond to thermoplastic liners with only a single coat and not requiring an extra coat of primer.

### BACKGROUND OF THE INVENTION

This invention relates to funeral burial vaults. More specifically, this invention relates to a plastic-lined concrete composite and method of making the same.

Presently in the art, when forming a burial vault a thermoplastic burial vault liner is treated with a coat of primer and then an adhesive before wet concrete is poured against the thermoplastic burial vault liner. U.S. Pat. Nos. 5,157,817 and 5,203,810 to Davidian (hereinafter the '817 and '810 patents) are directed toward this structure and method and provide for an adhesive that is formed of an epoxy resin system, a solvent and a surfactant.

While this adhesive has been used for many years and is effective at bonding thermoplastic with the wet concrete, users have recognized problems with the present adhesive. Specifically, the present adhesive does not fully bond with certain thermoplastic burial liners such as ABS (acrylonitrilebutadienestyrene) plastics. Consequently, current art entails the necessary application of a primer prior to the use of said adhesive or epoxy. The primer is used to etch the base plastic in order to create a surface facilitating full adhesion.

Because of the chemical nature of present adhesives, primer cannot simply be added directly to existing adhesives to overcome the problem of needing a primer coat before applying the adhesive. Specifically, when using the adhesive described in the '817 and '810 patents, in order to achieve the desired bond, a primer containing a high molecular weight terpolymer of vinyl chloride is required to ensure proper adhesion to an ABS substrate. The primer formula requires strong, flammable solvents to keep the terpolymer in the solution. The transportation, storage and handling of larger quantities of flammable materials is of great concern. For this reason, merely placing a primer into the adhesive taught in the '817 and '810 patents provides an undesirable result and an adhesive that not only is flammable but additionally cannot pass strict VOC (volatile organic compounds) regulations.

Therefore, a principal object of the present invention is to provide a plastic-lined concrete composite structure that uses an adhesive that eliminates the need for a primer coat.

Yet another object of the present invention is to provide a plastic-lined concrete composite structure that uses a non-flammable adhesive.

Yet another object of the present invention is to provide a method for producing a plastic-lined concrete composite structure that is able to pass VOC regulations.

These and other objects, features, or advantages of the present invention will become apparent from the specification and claims.

### BRIEF SUMMARY OF THE INVENTION

A composite structure and method of making the same. The composite structure has a rigid thermoplastic resin liner, an outer layer of concrete, and an intermediate layer of a cured thermosetting resin adhesive that bonds said thermoplastic resin liner to said outer layer of concrete. The adhesive is made up of an epoxy resin system, a solvent compatible with the epoxy resin system and capable of solubilizing the outer surface of said thermoplastic liner and a primer wherein the epoxy, solvent and primer form a solvent blend that retains the primer.

Additionally provided is a method of making the composite structure. The method includes molding a rigid thermoplastic liner and applying a thermosetting resin adhesive to a surface of the liner. The adhesive is as described above, an epoxy resin system, a solvent and a primer mixed together to form a solvent blend that retains the primer. Wet flowable concrete is applied to the adhesive layer and the adhesive and concrete are cured to provide a composite structure in which the concrete is firmly bonded to the liner.

### DETAILED DESCRIPTION OF THE PREFERRED EMBODIMENT

The adhesive is preferably an epoxy resin system that contains a substantial portion of a solvent for the thermoplastic liner and a primer. In general, the adhesive has the following composition in weight percentage:

| | |
|---|---|
| Epoxy resin system | 30-90% |
| Solvent | 5-60% |
| Primer | .1-8% |

The preferred composition of the adhesive is as follows:

| | |
|---|---|
| Epoxy resin system | 50-80% |
| Solvent | 10-40% |
| Primer | .25-3% |

The epoxy resin system is a conventional type and includes an epoxy resin and a curing agent for the epoxy resin, such as a polyamide resin.

The solvent to be used must be compatible with the epoxy resin system and must be capable of solubilizing the outer surface of the thermoplastic liner. Suitable solvents include aromatic solvents such as toluene, xylene, and trimethylbenzene; ketones such as methyl-n-amyl ketone, diethyl ketone, methylisobutyl ketone; esters such as ethyl acetate, glycoether acetate, amyl acetate; chlorinated solvents, such as methylene chloride, 1,1,1-trichloroethane, and the like.

The primer within the adhesive is able to provide an etched surface on the thermoplastic. As a result, the epoxy resin system and solvent are able to provide an improved strengthened bond between the thermoplastic and wet concrete. These primers include N-methyl pyrrolidone and/or vinyl resin.

The combination of the epoxy resin system, solvent and primer form a solvent blend. The solvent blend is a two-part resin system with the epoxy resin contained in one part and a curing agent accelerator in a second part. A typical adhesive formulation in weight percentage that can be used on the invention is as follows:

| Part A: | |
|---|---|
| bisphenol A-based epoxy resin | 31.158% |
| aromatic solvent (150 flash) | 9.346% |
| N-methyl pyrrolidone (primer) | 4.673% |
| vinyl resin (primer) | 0.584% |
| acrylic polymer (adhesion promoter) | 9.347% |
| fumed silica (thickener) | 0.623% |
| pigments and fillers | 43.489% |
| Part B: | |
| polyamide resins | 30.245% |
| aromatic solvent (150 flash) | 14.321% |
| fumed silica (thickener) | 0.02% |
| pigments and fillers | 55.4% |

Part A and Part B are mixed immediately prior to use to form the solvent blend. The solvent blend is applied evenly over the entire surface of the thermoplastic. After a venting period, the wet cement is poured into a mold and allowed to cure. The choice of solvents and adhesion promoters is critical to obtaining desired adhesion performance on the thermoplastic without compromising performance.

The adhesive with the new formula sticks to the thermoplastic without a primer coat. More specifically, the new formula allows for the adhesive to stick to ABS plastic without a primer coat, a result not previously accomplished. Additionally, the solvent blend is able to keep the terpolymer within the solution and simultaneously the solvent blend is not flammable. Further, the new formula also passes stricter VOC regulations in that less than 250 grams of volatile organic compound (VOC) per liter of the adhesive is present after the mixing of Part A and Part B.

In operation, the method of producing a plastic-lined concrete structure includes steps of molding a rigid thermoplastic liner. Next, a thermosetting resin adhesive is applied to the surface of the liner wherein the adhesive comprises an epoxy resin system, a solvent and a primer that together form a solvent blend that retains the primer. Next, wet flowable concrete is applied to the said adhesive layer and the concrete and adhesive are cured to provide a composite structure in which the concrete is firmly bonded to the liner.

Provided below are test results that show the strength of the adhesive of the present invention as compared to the adhesive taught in the '817 and '810 patents.

24 HOUR TEST RESULTS (RT, 0.005″, 0.5 in./min)

| | Strentex | Black ABS | CRS | CRS (90° F.) |
|---|---|---|---|---|
| Unidex A + | 134.5 psi (SF) | | 411.4 psi | 871.5 psi (CF) |
| Unidex B | | | (CF) | |
| | 120.5 psi (SF) | | 354.1 psi | 757.5 psi (CF) |
| | | | (CF) | |
| | Peel: OK | | | |
| Unidex Plus | 148.2 psi (SF) | 214.0 psi | 400.2 psi | 838.2 psi (CF) |
| | | (SF) | (CF) | |
| | 135.7 psi (SF) | 208.1 psi | 394.1 psi | 826.5 psi (CF) |
| | | (SF) | (CF) | |
| | Peel: Poor | Peel: Great | | |

7 DAY TEST RESULTS (RT, 0.005″, 0.5 in./min)

| | Strentex | Black ABS | CRS |
|---|---|---|---|
| Unidex A + | 113.5 psi (SF) | | 767.5 psi |
| Unidex B | | | (CF) |
| | 133.2 psi (SF) | | 891.5 psi |
| | | | (CF) |
| | Peel: Great | | |
| Unidex Plus | 145.7 psi (SF) | 166.8 psi (SF) | 777.6 psi |
| | | | (CF) |
| | 122.3 psi (SF) | 209.2 psi (SF) | 869.2 psi |
| | | | (CF) |
| | Peel: Great | Peel: Great | |

Two different tests are provided. The first measures the tensile strength required to pull a thermoformed plastic liner made of Strentex or black ABS plastic from a concrete slab when adhered to the slab with the adhesive of the Davidian references (referred to as Unidex A+ Unidex B) versus the adhesive of the present invention (labeled Unidex Plus). This test was performed both 24 hours after the adhesive was applied and 7 days after adhesion. The second test involved placing the adhesive between two cold rolled steel strips and testing the sheer strength of the adhesive. This included the testing of cold rolled steel at 90 degrees Fahrenheit, in both instances done at 24 hours after adhesion and 7 days after adhesion. In the testing the SF represents a substrate failure or a separation of the composite substrate and adhesive bond line where CF is representative of a cohesive failure.

The first test regarding the tensile strength required pulling the thermoformed plastic liner from the concrete slab. First, the adhesive to be tested is applied to the plastic specimen. Concrete is then poured such that a bond forms between the wet cement and the plastic specimen via the test adhesive. After proper cure time a core or round disk is formed into the liner and concrete to allow for testing of a specific unit area. During testing this area was 3.14 inches squared. A second adhesive is then applied to the cored out section to adhere the cored out section to a metal puck wherein the metal puck has a threaded section for receiving a threaded rod. The threaded rod is connected to an actuating member such that a hydraulic screw pump can be used to increase tensile force in order to determine the separation pressure. Specifically, the hydraulic screw pump pulls the metal puck upwards until the test adhesive fails. At that time the pressure of the screw pump is recorded to determine how much tensile force is required to create the failure.

The second test that is performed is that testing sheer. Specifically, first and second cold rolled steel plates are adhered together using the different adhesives. The two cold rolled steel plates are then pulled in opposite directions until failure occurs.

When looking at the tables, Unidex A+ Unidex B is the two-part adhesive disclosed in the '817 and '810 patents. The Unidex Plus is the adhesive disclosed in the present invention. As you can see from the results, the Unidex fails to bond to the black ABS plastic whereas the Unidex Plus is able to provide bonding and adhesion. Similarly, in both the twenty-four hour test and the seven-day test, the Unidex Plus adhesive outperforms the Unidex adhesive regarding the tensile strength testing.

Thus provided is an improved thermosetting resin adhesive that is able to bond a thermoplastic liner to wet cement. The improved thermosetting resin adhesive is formulated to have a solvent blend that keeps primer in a solution such that an individual coat of primer does not have to be placed on the liner before applying the adhesive. Additionally, the new formula provides a solvent blend that is not flammable eliminating the transportation, storage and handling issues associated with primers that are typically flammable. Specifically, the present solvent blend is able to pass strict VOC regulations wherein the solvent blend has less than 250 grams per liter of volatile organic compounds. Additionally, the new blend is able to provide bonding with only a single coat to plastic liners including ABS plastic wherein previously an additional coat of primer was needed. Thus, at the very least all the stated objectives have been met.

It will be appreciated by those skilled in the art that other various modifications could be made to the device without the parting from the spirit and scope of this invention. All such modifications and changes fall within the scope of the claims and are intended to be covered thereby.

What is claimed is:

1. A composite structure, comprising:
a rigid thermoplastic resin liner;
an outer layer of concrete;
an intermediate layer of a cured thermosetting resin adhesive bonding said liner to said outer layer,
said adhesive comprising an epoxy resin system,
a solvent compatible with the epoxy resin system and capable of solubilizing the outer surface of said thermoplastic liner, and
a primer capable of being retained within the epoxy resin system.

2. The composite structure of claim 1 wherein the adhesive is not flammable.

3. The composite structure of claim 1 wherein a primer coat is not placed on the liner.

4. The composite structure of claim 1 wherein said adhesive comprises by weight from 30-90% of said epoxy resin system, 5-60% of said solvent and 0.1-8% of primer.

5. The composite structure of claim 4 wherein said primer is selected from a group consisting of N-methyl pyrrolidone, vinyl resin and mixtures thereof.

6. The composite structure of claim 1 wherein the thermosetting resin adhesive comprises a first part mixed with a second part.

7. The composite structure of claim 6 wherein the first part is comprised of bisphenol A-based epoxy resin, aromatic solvent, N-methyl pyrrolidone, vinyl resin, acrylic polymer, fumed silica, pigments and fillers.

8. The composite structure of claim 7 wherein the second part comprises polyamide resins, aromatic solvent, fumed silica, pigments and fillers.

9. The composite structure of claim 1 wherein the thermoplastic resin liner is a thermoplastic liner.

10. A method of producing a plastic-lined concrete structure, comprising the steps of:
molding a rigid thermoplastic liner;
applying a thermosetting resin adhesive to a surface of said liner;
said adhesive comprising an epoxy resin system, a solvent compatible with said epoxy resin system and capable of solubilizing the outer surface of said liner, and a primer that forms a solvent blend such that the solvent blend retains the primer;
applying wet flowable concrete to said adhesive layer; and
curing said adhesive and said concrete to provide a composite structure in which the concrete is firmly bonded to the liner.

11. The method of claim 10 wherein the adhesive is not flammable.

12. The method of claim 10 wherein a primer coat is not placed on the liner.

13. The method of claim 10 wherein the primer comprises N-methyl pyrrolidone.

14. The method of claim 10 wherein the primer comprises vinyl resin.

15. The method of claim 10 wherein immediately before applying the thermosetting resin adhesive, the adhesive is formed by mixing a first part with a second part.

16. The method of claim 15 wherein the first part comprises bisphenol A-based epoxy resin; aromatic solvent, N-methyl pyrrolidone, vinyl resin, acrylic polymer, fumed silica, pigments and fillers.

17. The method of claim 16 wherein the second part comprises polyamide resins, aromatic solvent, fumed silica, pigments and fillers.

18. The method of claim 10 wherein the thermoplastic liner is a thermoplastic liner.

19. The method of claim 10 wherein the adhesive has less than 250 grams of volatile organic compound per liter of adhesive.
